(19) United States
(12) Patent Application Publication
(10) Pub. No.: US 2001/0033456 A1
(43) Pub. Date: Oct. 25, 2001

(54) Acoustic noise suppressor for a disc drive

(76) Inventor: Aaron Steve Macpherson, Fort Collins, CO (US)

Correspondence Address: Shawn B. Dempster, Seagate Technology LLC, Intellectual Property - SHK2LG, 1280 Disc Drive, Shakopee, MN, 55379, US

(21) Appl. No.: 09/838,926

(22) Filed: Apr. 20, 2001

Related U.S. Application Data
(60) Provisional application No. 60/199,042, filed on Apr. 21, 2000.

(51) Int. Cl. G11B 17/02

(52) U.S. Cl. 360/99.08

(57) ABSTRACT

An acoustic noise suppressor for a disc drive, the disc drive having a spinning spindle hub supporting a data disc in rotation. The suppressor comprises an annular spacer defining a bore, the spacer comprising a top surface and a bottom surface communicating with the longitudinal extents of the bore. A mass-loading element extends from the spacer opposite the bore, the mass-loading element comprising a top surface and a bottom surface in substantially parallel relation intermediate the spacer top and bottom surfaces.

### CROSS REFERENCE TO RELATED APPLICATION

This application claims the benefit of United States Provisional Application No. 60/199,042 entitled INTEGRAL DISC DRIVE SPACER AND DISC, filed Apr. 21, 2000.

### FIELD OF THE INVENTION

This invention relates generally to the field of disc drive data storage devices, and more particularly but not by way of limitation, to suppressing acoustic noise emissions in a disc drive.

### BACKGROUND OF THE INVENTION

Modern disc drives are commonly used in a multitude of computer environments to store large amounts of data in a form that is readily available to a user. Generally, a disc drive has a magnetic disc, or two or more stacked magnetic discs, that are rotated by a motor at a high speed. Each disc has a data storage surface divided into a series of generally concentric data tracks where data is stored in the form of magnetic flux transitions.

A data transfer member such as a magnetic transducer is moved by an actuator to selected positions adjacent the data storage surface to sense the magnetic flux transitions in reading data from the disc, and to transmit electrical signals to induce the magnetic flux transitions in writing data to the disc. The active elements of the data transfer member are supported by suspension structures extending from the actuator. The active elements are maintained a small distance above the data storage surface upon an air bearing generated by air currents caused by the spinning discs.

A continuing trend in the industry is toward ever-increasing data storage capacity and processing speed while maintaining or reducing the physical size of the disc drive. Consequently, the data transfer member and supporting structures are continually being miniaturized, and data storage densities are continually being increased. The result is an overall increased sensitivity to vibration, both from external sources and from self-excitation sources. These vibrations can have an adverse effect on the positioning control systems moving the actuator relative to the spinning discs.

These vibrations can also result in unacceptable levels of acoustic noise, which has increasingly become a problem as personal computers are used more directly in the user's work space. In many work environments a number of personal computers are clustered together within partitioned work areas, providing a cumulative noise effect that is often subject to regulation. This acoustic noise, which in the past was acceptable as the norm when the computers were relegated to a back-room, is now a significant factor in workplace environmental quality. Hence, disc drive manufacturers now have an increased awareness of the problem of acoustic noise.

One principal source of acoustic noise is the disc drive motor which mounts to the disc drive enclosure and supports one or more discs spinning at high speed. Analysis has determined that one mode of acoustic noise generation is sympathetic vibration of the enclosure in response to the spinning mass of the disc drive spindle assembly, which comprises the motor and the depending discs.

It has been found that by altering the mass-loading constituent of the disc drive spindle assembly, the frequency with which the enclosure vibrates can be changed to avoid resonant frequencies that would yield unacceptable acoustic noise. It is this invention which is discussed hereinbelow.

### SUMMARY OF INVENTION

The present invention is directed to suppressing acoustic noise emissions in disc drives. In one aspect of the present invention, an acoustic noise suppressor is provided for a disc drive having a spinning spindle hub supporting a data disc in rotation.

The suppressor comprises an annular spacer defining a bore, wherein the spacer comprises a top surface and a bottom surface communicating with the longitudinal extents of the bore. The spacer is positionable around the spindle hub so that a portion of the spindle hub is receivingly disposed in the bore, traversing the spacer top and bottom surfaces.

The suppressor furthermore comprises a mass-loading element extending from the spacer opposite the bore, wherein the mass-loading element comprises a top surface and a bottom surface in substantially parallel relation intermediate the spacer top and bottom surfaces.

In one embodiment the suppressor comprises a characteristic unitary construction. In an alternative embodiment the suppressor comprises a characteristic integral construction, and can comprise a constraint layer damping member as the mass-loading element.

### BRIEF DESCRIPTION OF THE DRAWINGS

FIG. 1 is a diagrammatic plan representation of a disc drive with the cover partially cut away, comprising an acoustic noise suppressor in accordance with an embodiment of the present invention.

FIG. 2 is a plan representation of the suppressor of FIG. 1.

FIG. 3 is a cross-sectional representation of the suppressor of FIG. 2 taken along the section line 3-3 therein, showing a characteristic unitary construction.

FIG. 4 is a partial cross-sectional representation of the disc drive spindle assembly of FIG. 1, showing the suppressor stacked between a single data disc and the enclosure base deck in accordance with one embodiment of the present invention.

FIG. 5 is an elevational representation of a portion of a disc drive spindle assembly similar to FIG. 4 but constructed in accordance with an alternative embodiment wherein the suppressor is stacked between a single data disc and the disc clamp.

FIG. 6 is an elevational representation of a portion of a disc drive spindle assembly similar to FIG. 5 but constructed in accordance with an alternative embodiment wherein the spacer portion of the suppressor is extended to eliminate the clamping ring.

FIG. 7 is a cross sectional representation of a suppressor similar to FIG. 3 but constructed in accordance with an alternative embodiment wherein the suppressor comprises a characteristic integral construction.

FIG. 8 is a cross sectional representation of a suppressor similar to FIG. 7 but constructed in accordance with an alternative embodiment wherein the mass-loading element comprises a constraint layer damping member.

FIG. 9 is an enlarged representation of a portion of the mass-loading element of FIG. 8.

### DETAILED DESCRIPTION OF THE PREFERRED EMBODIMENTS

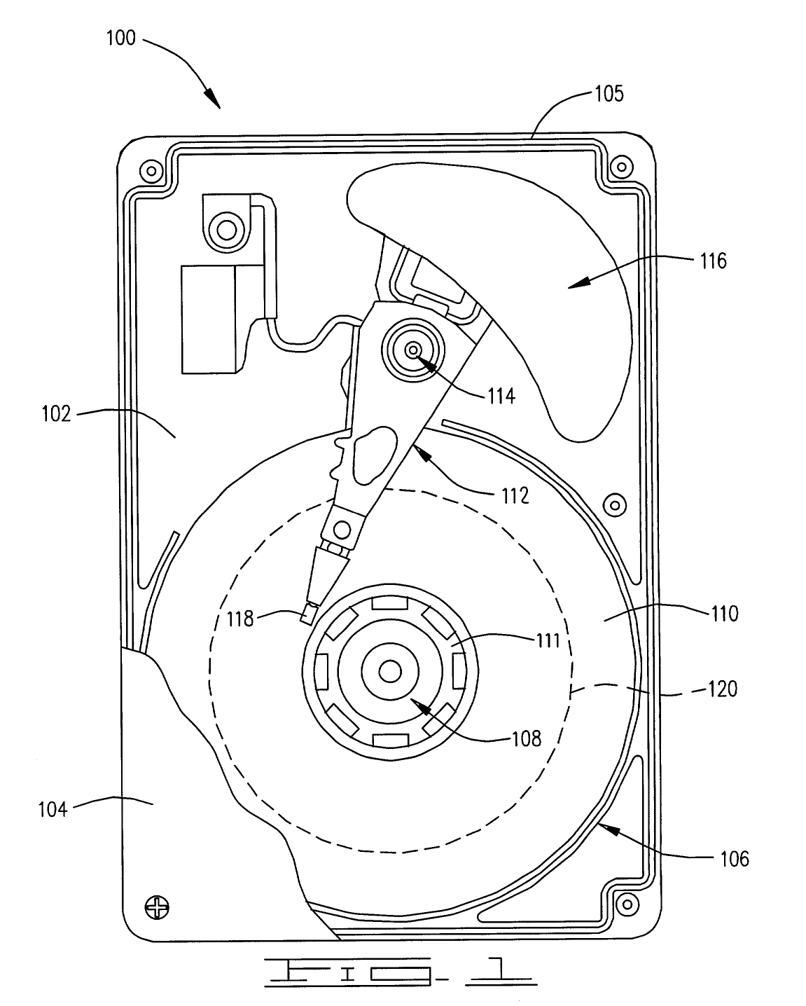

Referring to the drawings in general, and more particularly to FIG. 1, shown therein is a diagrammatic plan representation of a disc drive 100 constructed in accordance with an embodiment of the present invention. The disc drive 100 comprises a base deck 102 to which various disc drive 100 components are mounted, and a cover 104 (partially cut-away) which together with the base deck 102 and a perimeter gasket 105 form a sealed enclosure. Numerous details of construction are not included in the following description because they are well known to a skilled artisan and are unnecessary for an understanding of the present invention.

Mounted to the base deck 102 is a disc drive spindle assembly 106 comprising a spindle motor 108, one or more discs 1 10 coupled to the spindle motor 108, and a clamp 111 compressingly clamping the discs 110 in axial alignment with a spindle hub (shown below) of the spindle motor 108 for a fixed rotation therewith. The following description details the construction of a disc drive 100 having one disc 110, but alternatively two or more discs 110 can be supported by the spindle motor 108 and clamp 111. In the case of two or more stacked discs, spacers are inserted between adjacent discs 110 to provide access to data surfaces on both sides of each disc 110.

Data storage surfaces are formed by a magnetizable layer of media on the disc 110. An actuator 112 is pivoted around a bearing 114 by a voice coil motor 116 to move an array of read/write heads 118 across the data storage surfaces. The selected movement of the read/write head 118 in cooperation with the rotation of the disc 110 characterizes, in part, the disc drive 100 data reading and writing capability. That is, advancements in data processing speed have resulted in ever-faster disc 110 speed.

Higher rotation speeds can set up sympathetic vibrations on the enclosure in response to the rotating mass of the disc drive spindle assembly 106, resulting in unacceptably high levels of acoustic noise. The present invention alters the mass loading on the disc drive spindle assembly 106 to change the frequency at which the enclosure vibrates, thereby reducing acoustic noise.

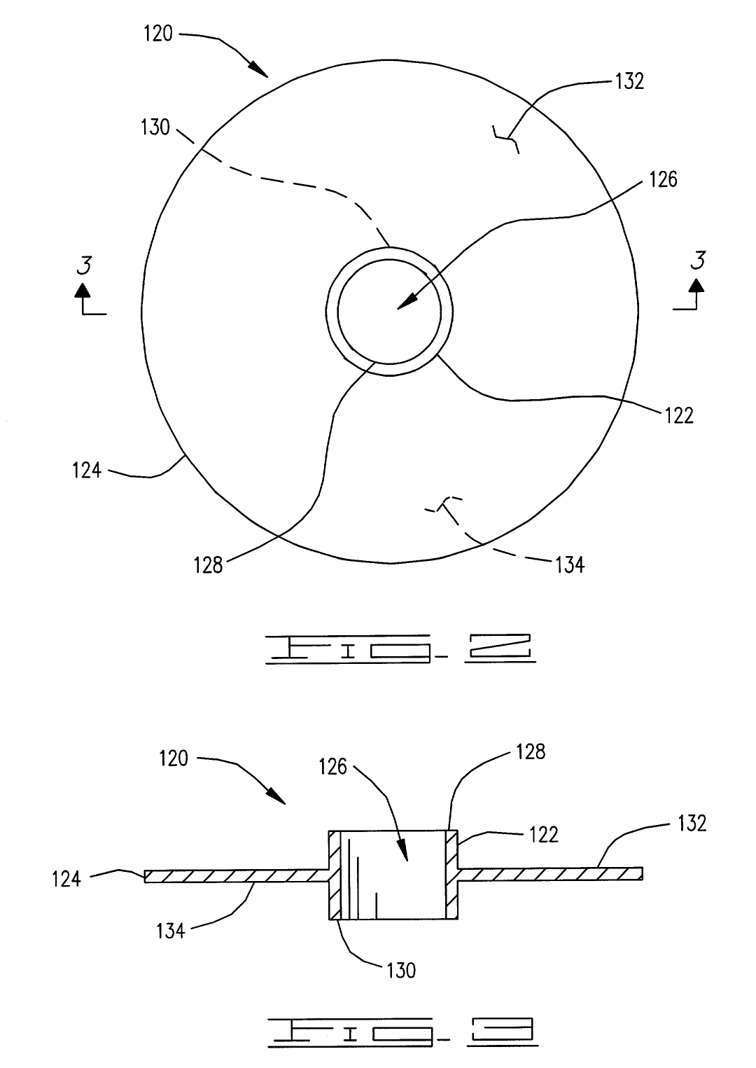

FIG. 1 shows the disc drive spindle assembly 106 further comprising a suppressor 120 stacked between the disc 110 and the base deck 102. Turning to FIGS. 2 and 3, the suppressor 120 comprises an annular spacer 122 and a mass-loading element (hereinafter “MLE”) 124. The spacer 122 defines a bore 126 communicating at an upper extent thereof with a top surface 128 of the spacer 122, and communicating at a lower extent thereof with a bottom surface 130 of the spacer 122. The spacer 122 is positionable around the spindle hub of the spindle motor 108 so that a portion of the spindle hub is receivingly disposed in the bore 126, traversing both the top and bottom surfaces 128, 130.

The MLE 124 extends generally radially from the spacer 122, in a direction opposite the bore 126. The MLE 124 comprises a top surface 132 and a bottom surface 134, both MLE surfaces 132, 134 being disposed intermediate the spacer top and bottom surfaces 128, 130, and generally in parallel relation with one another. The MLE surfaces 132, 134 define the longitudinal length, or thickness, of the MLE 124.

In a preferred embodiment, as shown in FIG. 3, the suppressor 120 is fashioned comprising a characteristic unitary construction. “Unitary construction” means the suppressor 120 is characterized by unity, being undivided and whole. Namely, this means the spacer 122 and the MLE 124 are manufactured as a continuous, single-part component. The unitary construction addresses some manufacturability concerns associated with minimizing part count and assembly procedure complexity.

The spacer 122 must be substantially noncompressible to resist distortion under the relatively high compressive clamping load of the clamp 111 (FIG. 1). Accordingly, in a preferred embodiment the characteristic unitary construction of FIG. 3 can comprise a relatively rigid material such as formed or machined aluminum.

The mass-loading element 124 is preferably a circular member, extending radially to form a planar member substantially equidistantly interposed between the spacer top and bottom surfaces 128, 130. It has been determined that a sufficient acoustic noise suppression can be achieved with a suppressor 120 comprising an MLE 124 thickness substantially the same as the disc 110 and comprising an MLE diameter that is substantially less than the disc 110 diameter. In one particular case, for example, it was determined that for a substantially constant thickness of disc 110 and MLE 124, a single-disc drive spindle assembly 106 comprising a 95 millimeter (“mm”) disc 110 was effectively acoustically suppressed by a suppressor 120 with a 65 mm diameter MLE 124. Reducing the MLE 124 size advantageously reduces the suppressor 120 part cost.

In this example, for a substantially constant thickness the optimal MLE-to-disc diameter ratio was about 0.68. The preferred ratio is a function of the mass contained in the MLE 124, so the optimal MLE 124 diameter is inversely related to the thickness of the MLE 124. The determinative design factor concerns, regardless of the selected thickness or diameter, the mass of the MLE 124 which must provide a sufficient rotational inertia to alter the frequency at which the enclosure vibrates so as to eliminate undesirable acoustic noise.

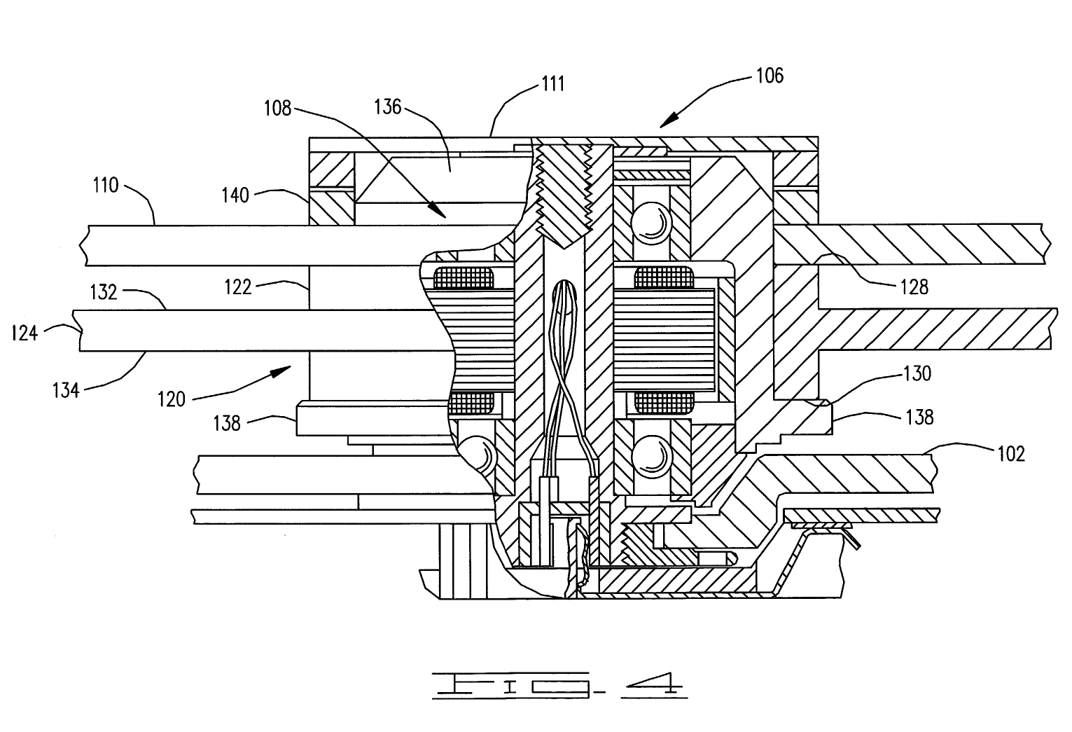

Turning now to FIG. 4 which illustrates a partial cross sectional view of the disc drive spindle assembly 106 of FIG. 1. The spindle motor 108 comprises a rotatable spindle hub 136 and an appropriate power transmission arrangement to rotate the spindle hub 136 relative to the base deck 102 of the disc drive 100 enclosure. The spindle motor 108 of FIG. 4 is a ball bearing motor, but the present invention also contemplates the use of a suppressor 120 in combination with other types of power transmission arrangements such as with a hydrodynamic bearing motor (not shown).

In FIG. 4 the suppressor 120 is stacked between the disc 110 and the base deck 102, as in FIG. 1. One way of supporting the suppressor 120 in this stacked arrangement is by the spindle hub 136 comprising a radially extending hub flange 138 that abuttingly engages the spacer lower surface 130. The disc 110 is stacked to abuttingly engage the spacer top surface 128. Typically, a clamp ring 140 (cross-sectional shown) is disposed above the top disc 110 and the clamp 111 is attached with fasteners (not shown) to compressingly engage the clamp ring 140, the disc (or discs) 110, and the suppressor 120 so as to align all in longitudinal alignment and fixed rotation with the spindle hub 136.

FIG. 5 is a view of a portion of a disc drive spindle assembly 106 illustrating an alternative stacking arrangement wherein the suppressor 120 is stacked between the disc 110 and the clamp 111 at the distal end of the spindle hub 136. In this case, the disc 110 is supported by the hub flange 138 and abuttingly engages, in turn, the spacer bottom surface 130. The clamp ring 140 abuttingly engages the spacer top surface 128, and all are compressingly fixed by the clamp 111 as above.

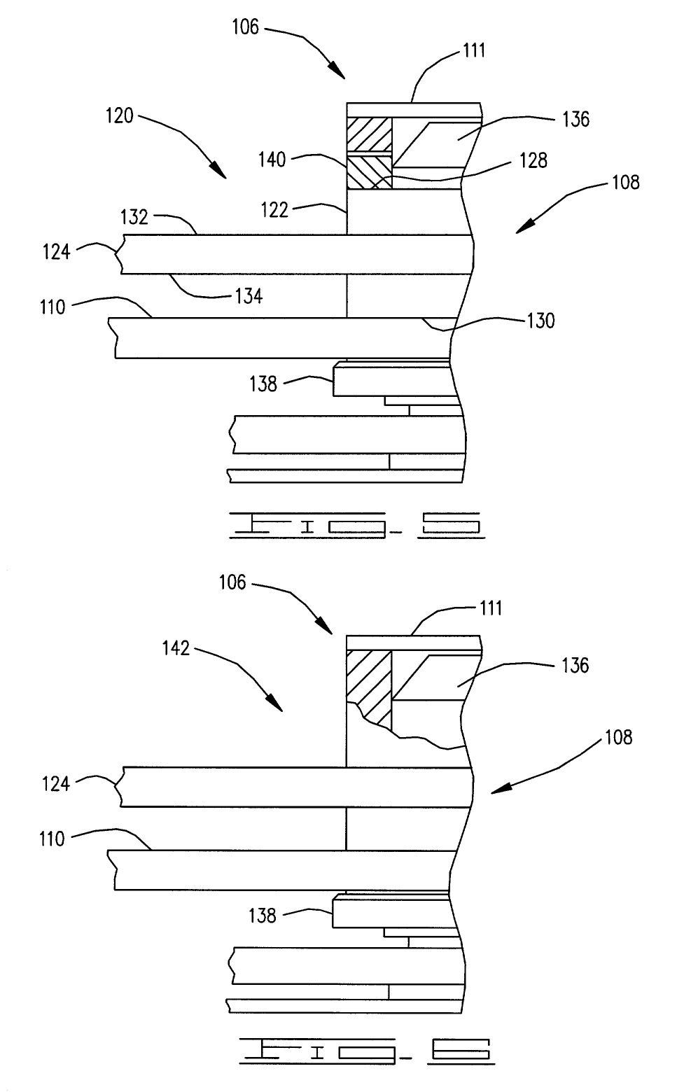

FIG. 6 illustrates an alternative spacer 142 used in the stacking arrangement of FIG. 5. The longitudinal length of the spacer 142 is increased in order to eliminate the need for the clamp ring 140. Note that the MLE 124 can be interposed non-equidistantly from the spacer ends to provide a desired spacing between the top disc 110 and the MLE 124.

Heretofore, the suppressor 120 has been contemplated as comprising a characteristic unitary construction. FIG. 7 illustrates one alternative embodiment wherein a suppressor 144 comprises a characteristic integral construction. “Integral construction” means the suppressor 144 is characterized by a manufacture such that a unit is formed by the joinder of two or more parts. Namely, this means a spacer 146 and a MLE 148 are manufactured individually and joined together. Alternatively, the MLE 148 can be overmolded to the spacer 146. The integral construction advantageously permits the spacer 146 and the MLE 148 to be fashioned of materials selected to optimize the individual functionality. For example, even though the spacer 146 is necessarily a rigid, substantially non-compressible material to withstand the clamping force, the MLE 148 can be made from a less expensive material such as a polymeric material.

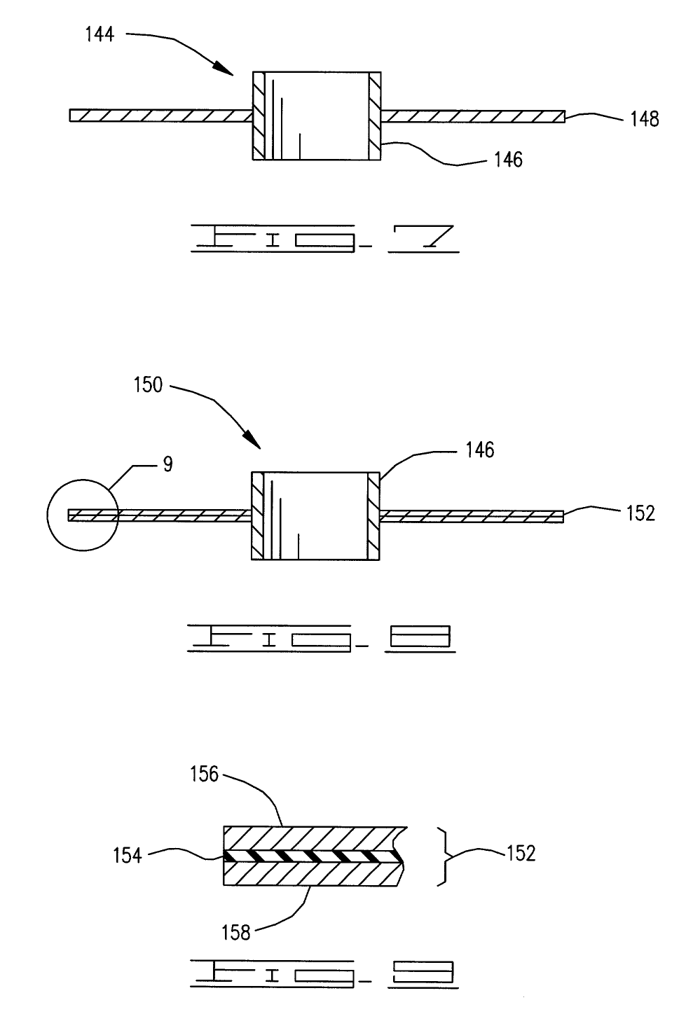

Finally, FIGS. 8 and 9 illustrate a suppressor 150 comprising a characteristic integral construction similar to FIG. 7, but further comprising an MLE 152 comprising a characteristic constraint layer damping member. “Constraint layer damping” means a laminated assembly comprising a damping member to attenuate vibrations. FIG. 9 is an enlarged detail of a portion of the MLE 152. An elastomeric member 154 is sandwiched between an upper member 156 and a lower member 158. The members 156, 158 are preferably substantially rigid, planar, circular members as above, comprising aluminum or a polymeric material. The sandwiched construction can be provided by any well known methodology such as with adhesive or thermal bonding.

In summary, the present invention provides a disc drive (such as 100) comprising an actuator (such as 112) supporting a data transfer member (such as read/write head 118) in a data reading and writing relationship with a data storage disc (such as 110). A disc drive spindle assembly (such as 106) comprises a drive motor (such as spindle motor 108) supported upon an enclosure portion (such as base deck 102) of the disc drive, the drive motor spinning a spindle hub (such as 136) which supports, in turn, the data storage disc.

The disc drive spindle assembly furthermore comprises an acoustic noise suppressor (such as 120) supported by the spindle hub and fixed with the'discs in rotation. The suppressor comprises a spacer (such as 122) defining a bore (such as 126), the spacer comprising a top surface (such as 128) and a bottom surface (such as 130) communicating with the longitudinal extents of the bore. The spacer is positionable around the spindle hub so that a portion of the spindle hub is receivingly disposed in the bore, traversing the spacer top and bottom surfaces.

The suppressor furthermore comprises a mass-loading element (such as 124) extending radially from the spacer opposite the bore. The mass-loading element has a top surface (such as 132) and a bottom surface (such as 134) disposed substantially in parallel relation, intermediate the spacer top and bottom surfaces. The mass-loading element alters the frequency at which the disc drive enclosure would otherwise vibrate without the mass-loading element, in response to the spinning data discs, thereby reducing the acoustic noise emissions in the disc drive.

It is clear that the present invention is well adapted to attain the ends and advantages mentioned as well as those inherent therein. While a presently preferred embodiment of the invention has been described for purposes of the disclosure, it will be understood that numerous changes may be made in the construction, operation and arrangement of the various elements, steps and procedures without departing from the spirit and scope of the invention as defined in the following claims.

What is claimed is:

1. An acoustic noise suppressor for a disc drive, the disc drive having a spinning spindle hub supporting a data disc in rotation, the suppressor comprising:
an annular spacer defining a bore, the spacer comprising a top surface and a bottom surface communicating with the longitudinal extents of the bore, the spacer positionable around the spindle hub so that a portion of the spindle hub is receivingly disposed in the bore, traversing the spacer top and bottom surfaces; and
a mass-loading element extending from the spacer opposite the bore, the mass-loading element comprising a top surface and a bottom surface in substantially parallel relation intermediate the spacer top and bottom surfaces.

2. The suppressor of claim 1 comprising a characteristic unitary construction.

3. The suppressor of claim 2 comprising aluminum.

4. The suppressor of claim 1 wherein the mass-loading element comprises a circular member.

5. The suppressor of claim 1 wherein the mass-loading element comprises a substantially planar member.

6. The suppressor of claim 5 wherein the mass-loading element is substantially equidistantly interposed between the spacer top and bottom surfaces.

7. The suppressor of claim 4 wherein the mass-loading element adaptively comprises a diameter substantially less than the data disc diameter.

8. The suppressor of claim 7 wherein the mass-loading element adaptively comprises a mass-loading element diameter to data disc diameter ratio of approximately 0.68.

9. The suppressor of claim 5 wherein the mass-loading element is substantially non-equidistantly interposed between the spacer top and bottom surfaces.

10. The suppressor of claim 1 comprising a characteristic integral construction.

11. The suppressor of claim 10 wherein the mass-loading element comprises a polymeric member.

12. The suppressor of claim 11 wherein the mass-loading element comprises a constraint layer damping member.

13. A disc drive spindle assembly, comprising;
a rotatable spindle hub;
a data disc coupled to the spindle hub;
an acoustic noise suppressor, comprising:
an annular spacer defining a bore, the spacer comprising a top surface and a bottom surface communicating with the longitudinal extents of the bore, the spacer positioned around the spindle hub so that a portion of the spindle hub is receivingly disposed in the bore, traversing the spacer top and bottom surfaces; and
a mass-loading element extending from the spacer opposite the bore, the mass-loading element comprising a top surface and a bottom surface in substantially parallel relation intermediate the spacer top and bottom surfaces; and
a disc clamp clamping the data disc and the suppressor in axial alignment for fixed rotation with the spindle hub.

14. The disc drive spindle assembly of claim 13 wherein the spindle hub further comprises a radially extending hub flange, wherein the hub flange abuttingly engages the spacer bottom surface and the data disc abuttingly engages the spacer top surface.

15. The disc drive spindle assembly of claim 13 wherein the disc clamp abuttingly engages the spacer top surface and the data disc abuttingly engages the spacer bottom surface.

16. The disc drive spindle assembly of claim 13 wherein the suppressor comprises a characteristic unitary construction.

17. The disc drive spindle assembly of claim 13 wherein the suppressor comprises a characteristic integral construction.

18. The disc drive spindle assembly of claim 17 wherein the mass-loading element comprises a polymeric member.

19. The disc drive spindle assembly of claim 18 wherein the mass-loading element comprises a constraint layer damping member.

20. A disc drive, comprising:
an enclosure;
a motor supported by the enclosure and spinning, in turn, a data disc; and
suppressor means interposed between the spinning data disc and a portion of the enclosure for suppressing acoustic noise generated by the spinning data disc.
